(19) United States
(12) Patent Application Publication
(10) Pub. No.: US 2019/0073672 A1
(43) Pub. Date: Mar. 7, 2019

(54) EMERGENCY TRIGGERED RESOURCE DISTRIBUTION NETWORK DEPLOYMENT SYSTEM

(71) Applicant: BANK OF AMERICA CORPORATION, Charlotte, NC (US)

(72) Inventors: Joseph Benjamin Castinado, North Glenn, CO (US); Samuel Massa Moiyallah, JR., Newark, DE (US)

(21) Appl. No.: 15/694,282

(22) Filed: Sep. 1, 2017

(51) Int. Cl. G06Q 20/40; H04L 12/24; G06Q 50/00; G06Q 20/16

(52) U.S. Cl. CPC G06Q 20/405; H04L 41/12; H04W 4/22; G06Q 20/16; G06Q 50/01

(57) ABSTRACT

Embodiments of the invention are directed to systems, methods, and computer program products for an emergency triggered system for resource distribution network generation and deployment. In this way, the invention interconnects with a digital resource distribution network for real-time resource transfer from user contacts to a user only enacted upon confirmation of a triggering event. As such, upon triggering status enablement, the system may form and activate a user specific resource distribution depository network for user aid via integration within a digital resource distribution network platform.

### BACKGROUND

With advancements in technology, instantaneous user resource access and distribution is becoming easier. As such, a need exists for relief resource distribution and access.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention are directed to systems, methods, and computer program products for an emergency triggered system for resource distribution network generation and deployment. In this way, the invention interconnects with a digital resource distribution network for real-time resource transfer from user contacts to a user only enacted upon confirmation of a triggering event. As such, upon triggering status enablement, the system may form and activate a user specific resource distribution depository network for user aid via integration within a digital resource distribution network platform.

In some embodiments, the invention generates an emergency triggered resource distribution depository network for resource deployment based on the emergency. In this way, the system utilizes a digital resource distribution network interconnected to a financial institution to allow generation of an emergency status within a user network account. In some embodiments, the status may not be formally known to the user and only enacted when the institution confirms a disaster or emergency situation has occurred. When the status is enabled, the system may form and activate a resource distribution depository network for user aid.

Furthermore, in some embodiments, the system may link into social networking platforms via integration for indication of a user being safe or affected by an emergency. In this way, the resource distribution depository network may be tied to social awareness for triggering.

For example, a natural disaster may hit a geographic location associated with the user. According to weather media the geographic location hit by the disaster was in direct coordination with a location associated with the user. The system may identify the user as being within the geographic location hit by the disaster and may reach out to the user to determine the user's status. The system coordinates with social media outlets for social awareness to identify if the user or the area was hit by the disaster. The system may, in some embodiments, push a request to the user, upon triggered identification of the emergency, to initiate a resource distribution depository network for that user. In other embodiments, based on collection of data from social media outlets, weather media, user account information, and the like the system may automatically generate a resource distribution depository network for the user. Upon approval or automatic determination, the system may push notifications to user contacts and social media platforms of the resource distribution depository network generated for the user. As such, the user contacts may provide funds to the user.

Embodiments of the invention relate to systems, methods, and computer program products for resource distribution depository network deployment, the invention comprising: interconnecting with a digital resource distribution network for generation of a resource distribution depository network for a user based on triggering of an event; generating a communicable linkage with an emergency confirmation network comprising third party systems; triggering, based on identification of a user experiencing an event, a generation of the resource distribution depository network for the user; communicating with emergency confirmation network to confirm event occurrence; transmitting a communication to the user confirming the user safety after the event; generating the resource distribution depository network via communication with the digital resource distribution network; communicating the resource distribution depository network to a user contact network with one or more user contacts based on user authorization for the resource distribution depository network; and allowing resource distribution from the user contact network to the user via the resource distribution depository network.

In some embodiments, generating the resource distribution depository network via communication with the digital resource distribution network further comprises integration within the digital resource distribution network and manipulating the digital resource distribution network for generation of an individual directed resource distribution depository network for the user.

In some embodiments, the emergency confirmation network comprises communicably linked third party network servers associated with media outlets, weather outlets, social network outlets, and resource deployment outlets.

In some embodiments, an event is an emergency or natural disaster negatively impacting the user resource availability, physical health, or property health.

In some embodiments, identification of the user experiencing an event further comprises receiving communication from the user of the event and a request for the generation of the resource distribution depository network for the user.

In some embodiments, identification of the user experiencing an event further comprises receiving communication from the emergency confirmation network or user contact network providing an indication of the event for a user.

In some embodiments, authorizing the user for the resource distribution depository network further comprises filtering factors of a number of user requests received this year, a reason for a request, a resource amount requested, and user resource trends for user authorization for generation of the resource distribution depository network.

In some embodiments, the user contact network further comprises one or more individuals linked to the user via social network contacts of the user or phonebook contacts of the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates an emergency triggered resource distribution deployment system environment, in accordance with embodiments of the present invention;

FIG. 2 illustrates a high level flowchart of system interaction within the emergency triggered resource distribution deployment system environment, in accordance with embodiments of the present invention;

FIG. 3 illustrates a high level flowchart of emergency triggered resource distribution network deployment, in accordance with embodiments of the present invention;

FIG. 4 illustrates a process for initiation of the emergency triggered resource distribution network, in accordance with embodiments of the present invention; and

FIG. 5 illustrates a process for validation authorization for deployment of emergency triggered resource distribution network, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the distribution of money or other funds from one account to another.

In some embodiments, a “resource distribution document” as used herein may refer to any paper document or digital signal that may transfer or exchange resources, such as funds, across individuals or entities. Resource distribution documents may include checks, certified checks, automated clearing house, contract, person-to-person payments, credit card payments, debit card payments, transfers of cash, or the like.

As used herein, the term “resource” may be used to refer to elements of one or more computing devices, networks, or the like available to be used in the execution of tasks or processes. A resource may include processor, memory, or network bandwidth and/or power used for the execution of tasks or processes. A resource may be used to refer to available processing, memory, and/or network bandwidth and/or power of an individual computing device as well a plurality of computing devices that may operate as a collective for the execution of one or more tasks (i.e., nodes of a distributed computing cluster).

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself. In some embodiments, an emergency may be any sort of natural disaster, financial hardship, physical hardship, or familial hardship that may adversely affect the user and his/her resource stream.

In some embodiments, the invention generates an emergency triggered resource distribution depository network for resource deployment based on the emergency. In this way, the system utilizes a digital resource distribution network interconnected to a financial institution to allow generation of an emergency status within a user network account. In some embodiments, the status may not be formally known to the user and only enacted when the institution confirms a disaster or emergency situation has occurred. When the status is enabled, the system may form and activate a resource distribution depository network for user aid.

Furthermore, in some embodiments, the system may link into social networking platforms via integration for indication of a user being safe or affected by an emergency. In this way, the resource distribution depository network may be tied to social awareness for triggering.

For example, a natural disaster may hit a geographic location associated with the user. According to weather media the geographic location hit by the disaster was in direct coordination with a location associated with the user. The system may identify the user as being within the geographic location hit by the disaster and may reach out to the user to determine the user's status. The system coordinates with social media outlets for social awareness to identify if the user or the area was hit by the disaster. The system may, in some embodiments, push a request to the user, upon triggered identification of the emergency, to initiate a resource distribution depository network for that user. In other embodiments, based on collection of data from social media outlets, weather media, user account information, and the like the system may automatically generate a resource distribution depository network for the user. Upon approval or automatic determination, the system may push notifications to user contacts and social media platforms of the resource distribution depository network generated for the user. As such, the user contacts may provide funds to the user.

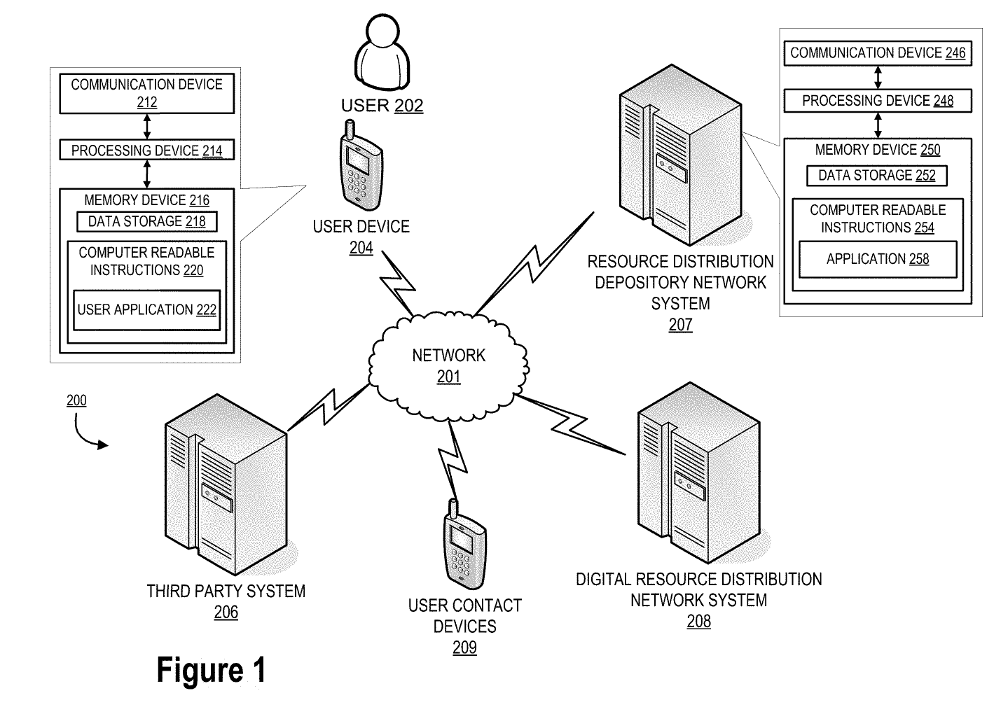

FIG. 1 illustrates an emergency triggered resource distribution deployment system environment 200, in accordance with embodiments of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of real-time emergency generation and triggering of resource distribution depository networks for emergencies.

As illustrated in FIG. 1, the digital resource distribution network system 208 is operatively coupled, via a network 201 to the user device 204, resource distribution depository network system 207, user contact devices 209, and to the third party system 206. In this way, the digital resource distribution network system 208 can send information to and receive information from the user device 204, resource distribution depository network system 207, and the third party system 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is one or more individuals receiving or resources from the resource distribution depository network based on a triggering of an emergency event. The user may have one or more accounts associated with resources for distribution such as checks, person-to-person payments, debit cards, credit cards, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the third party system 206, the digital resource distribution network system 208, and the resource distribution depository network system 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to set up marker codes and communicate with the third party system 206.

As further illustrated in FIG. 1, the resource distribution depository network system 207 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the digital resource distribution network system 208, the third party system 206, and the user device 204. As such, the communication device 246 generally comprises a modem, server, or other device for communicating with other devices on the network 201.

As further illustrated in FIG. 1, the resource distribution depository network system 207 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the resource distribution depository network system 207 the memory device 250 stores an application 258. Furthermore, the resource distribution depository network system 207, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more digital resource distribution network system 208, resource distribution depository network system 207, and/or user device 204.

As illustrated in FIG. 1, the third party system 206 is connected to the digital resource distribution network system 208, user device 204, user contact devices 209, and resource distribution depository network system 207. The third party system 206 has the same or similar components as described above with respect to the user device 204 and the resource distribution depository network system 207.

As illustrated in FIG. 1, the user contact devices 209 is connected to the digital resource distribution network system 208, user device 204, third party system 206, and resource distribution depository network system 207. The user contact devices 209 has the same or similar components as described above with respect to the user device 204.

As illustrated in FIG. 1, the digital resource distribution network system 208 is connected to the resource distribution depository network system 207, user device 204, user contact devices 209, and third party system 206. In other embodiments, the digital resource distribution network system 208 may be a third party system separate from the third party system 206. The digital resource distribution network system 208 has the same or similar components as described above with respect to the user device 204 and the third party system 206. While only one digital resource distribution network system 208 is illustrated in FIG. 1, it is understood that multiple digital resource distribution network system 208 may make up the system environment 200.

In some embodiments, the digital resource distribution network system 208 is a digital payments network that enables individuals and entities to electronically transfer resources from an account to another account using a web interface. In this way, the payer does not need to know the account information of the payee to make the payment. Instead, that information is held via digital resource distribution network system 208 and the payer identified the payee via a unique identifier.

It is understood that the servers, systems, and devices described herein illustrate one embodiment of the invention. It is further understood that one or more of the servers, systems, and devices can be combined in other embodiments and still function in the same or similar way as the embodiments described herein. The digital resource distribution network system 208 may generally include a processing device communicably coupled to devices as a memory device, output devices, input devices, a network interface, a power source, one or more chips, and the like. The digital resource distribution network system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the digital resource distribution network system 208 described herein

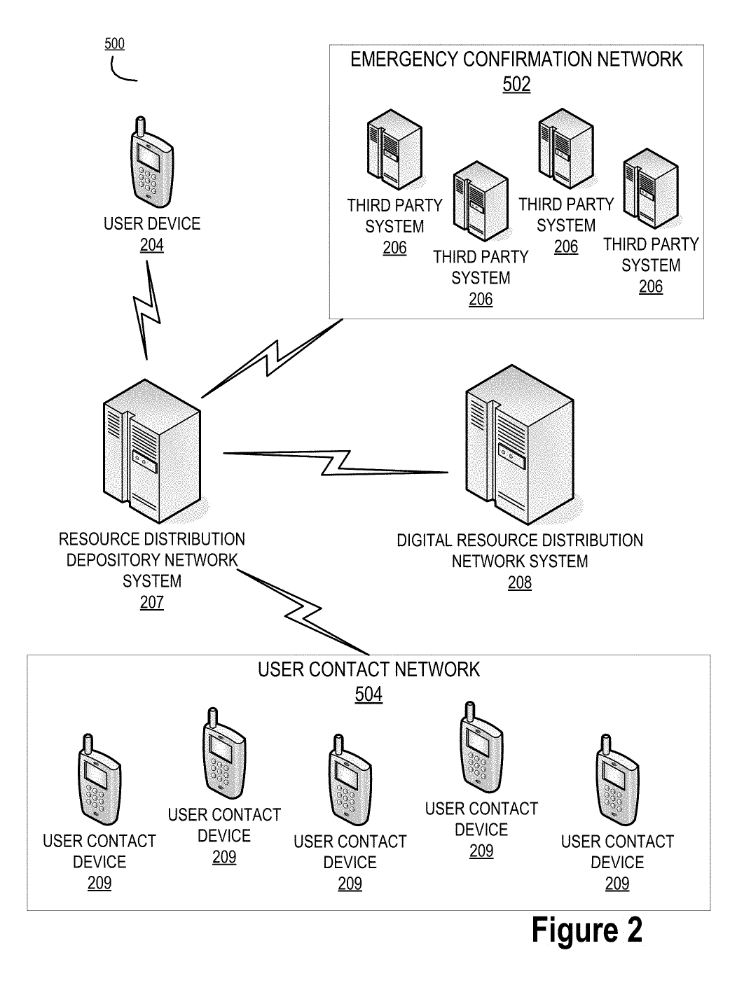

FIG. 2 illustrates a high level flowchart of system interaction within the emergency triggered resource distribution deployment system environment 500, in accordance with embodiments of the present invention.

In some embodiments, the invention generates an emergency triggered resource distribution depository network for resource deployment based on the emergency. In this way, the system utilizes a digital resource distribution network interconnected to a financial institution to allow generation of an emergency status within a user network account. In some embodiments, the status may not be formally known to the user and only enacted when the institution confirms a disaster or emergency situation has occurred. When the status is enabled, the system may form and activate a resource distribution depository network for user aid.

As illustrated, the resource distribution depository network system 207 interconnects, communicates with, and/or manipulates other devices and networks, such as the user contact network 504 consisting of user conduce devices 209, the digital resource distribution network system 208, the user device 204, and/or the emergency confirmation network 502, consisting generally of third party systems 206.

The resource distribution depository network system 207 communicates with these other networks and devices in order to generate a resource distribution depository network for a user in need based on indication of a disaster or emergency effecting the user.

As illustrated, the resource distribution depository network system 207 may monitor an emergency confirmation network 502 to identify an emergency occurrence. In other embodiments, the resource distribution depository network system 207 may receive an emergency occurrence message from the user via a user device 204. In some embodiments, the emergency confirmation network 502 may comprise one or more third party systems 206. These third party systems 206 may be social media systems and networks, weather media networks, news networks, user account status networks, and the like to determine if an emergency may have been identified as effecting the user or a geographic location the resource distribution depository network system 207 identifies as being associated with the user.

Upon identification of an emergency event potentially effecting the user, the resource distribution depository network system 207 may communicate with the user via the user device 204. In this way, the resource distribution depository network system 207 may communicate to confirm the user safety during the event. Furthermore, the system may request user authorization for generation of a resource distribution depository network for the user directed towards the specific emergency identified. The resource distribution depository network system 207 may communicate with a digital resource distribution network system 208 in order to set up a resource distribution depository network for the user. The digital resource distribution network may be a digital means for transferring resources from an individual to another individual without need for any account information. In this way, the digital resource distribution network system 208 is a digital payments network that enables individuals and entities to electronically transfer resources from an account to another account using a web interface. In this way, the payer does not need to know the account information of the payee to make the payment. Instead, that information is held via digital resource distribution network system 208 and the payer identified the payee via a unique identifier.

Upon set up of the resource distribution depository network, the resource distribution depository network system 207 may generate a user contact network 504. This network may include friends, family, or other individuals associated with the user. The user contact network 504 may be identified based on user input, social networking, geographic location, user contacts from a mobile device, or the like. The resource distribution depository network system 207 may then transmit the generated resource distribution depository network to each of the user contact devices 209 associated with user contacts within the user contact network 504. The user contacts, via the user contact devices 209 may provide resources to the user to aid the user during the emergency.

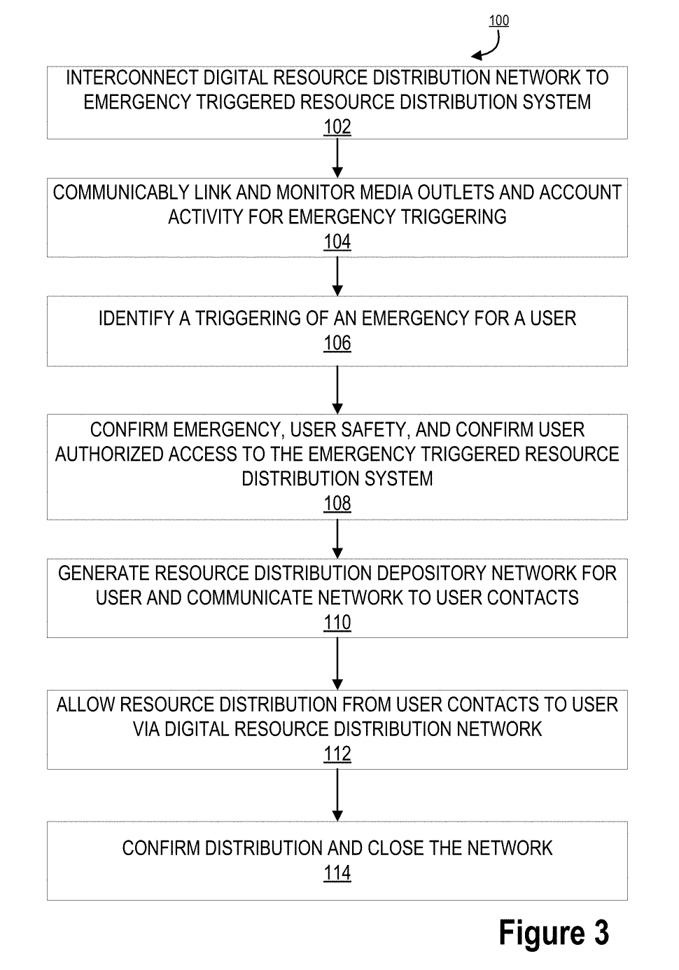

FIG. 3 illustrates a high level flowchart of emergency triggered resource distribution network deployment 100, in accordance with embodiments of the present invention. As illustrated in block 102, the process 100 is initiated by interconnecting a digital resource distribution network to the emergency triggered resource distribution system. In some embodiments, the digital resource distribution network system is a digital payments network that enables individuals and entities to electronically transfer resources from an account to another account using a web interface. In this way, the payer does not need to know the account information of the payee to make the payment. Instead, that information is held via digital resource distribution network system and the payer identified the payee via a unique identifier.

Next, the process 100 continues by communicably linking to and monitoring media outlets and account activity for emergency triggers, as illustrated in block 104. In this way, the system may link to media outlets such as news outlets, weather outlets, emergency response team outlets, or the like in order to identify a potential emergency, such as a natural disaster, man-made disaster, personal financial emergency, or the like. These outlets may include web based outlets.

Next, as illustrated in block 106, the process 100 continues by identifying a triggering of an emergency for a user. In some embodiments, the system, via the communicable linkages with media and account outlets may identify a triggering of an emergency for a user. In other embodiments, the user may communicate a triggering of an emergency. In some embodiments, a user may be associated with the system by having an account with the entity providing the system. In some embodiments, a user may be associated with the system by user enrollment into the system. In some embodiments, a user may be associated with the system by being in a geographically area identified as being effected by an emergency.

As illustrated in block 108, the system may confirm the emergency, user safety, and user authorization access into the emergency triggered resource distribution system. In some embodiments, the system may confirm the emergency. In this way, the system may contact the user and confirm the emergency and the effect on the user to confirm that the user desires a resource distribution depository network to be generated for the user. Furthermore, the system may review outlets and/or user accounts for confirmation of the emergency effecting the user based on geographic location matching between the emergency and the user, resources available for the user, or the like. In some embodiments, the system may confirm user safety. In this way, the system may transmit a communication to the user via the user device. The communication may require user interaction to confirm the user is safe from the emergency or disaster. The communication may be in the form of a voice communication, text communication, or the like. Furthermore, the system may identify one or more needs of the user, such as resources, food, shelter, water, or the like. The system may be able to deploy and display those needs to the user contacts for the user contacts to provide items or prepaid resource cards associated with stores for the desired products. In some embodiments, the system may confirm user authorization access into the emergency triggered resource distribution system for receiving a resource distribution depository network. In this way, the system determines that the user is authorized for the resource distribution depository network. This may include one or more parameters for resource distribution depository network deployment such as a maximum number of resource distribution depository networks established for the user within a given time period.

Next, as illustrated in block 110, the process 100 continues by generating a resource distribution depository network for the user and communicating the resource distribution depository network to the user contacts. In this way, the system identifies one or more user contacts, such as individuals associated with the user via social media, in the user's address book, user provided individuals, or the like. The system may generate the resource distribution depository network and communicate that network to the user contacts. The resource distribution depository network may be a network associated with the resource distribution depository network system for digital distribution of resources by the contacts to the user.

The system may keep the resource distribution depository network open for a duration of time. Upon ending of the resource distribution depository network, the system may confirm distribution of resources to the user and close the resource distribution depository network, as illustrated in block 114.

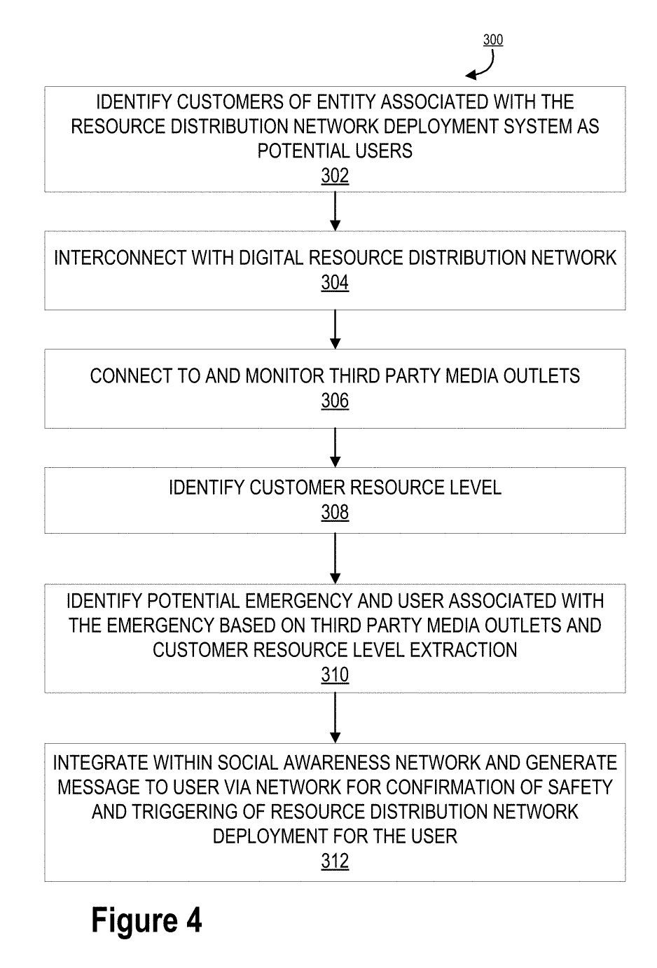

FIG. 4 illustrates a process for initiation of the emergency triggered resource distribution network 300, in accordance with embodiments of the present invention. As illustrated in block 302, the process 300 is initiated by identifying customers of the entity associated with the resource distribution network deployment system as potential users. The entity may be a financial institution or the like. The customers may be one or more potential users of the resource distribution network deployment system based on customer need and/or customer situation.

As illustrated in block 304, the process 300 continues by interconnecting and providing system integration with a digital resource distribution network. In some embodiments, the digital resource distribution network system is a digital payments network that enables individuals and entities to electronically transfer resources from an account to another account using a web interface. In this way, the payer does not need to know the account information of the payee to make the payment. Interconnection may occur via a private secure network channel wherein the system may integrate into the digital resource distribution network and provide an individualized resource distribution depository network for the system based on request.

Next, as illustrated in block 306, the process 300 continues by connecting to and monitoring third party media outlets. In this way, the system may link to media outlets such as news outlets, weather outlets, emergency response team outlets, or the like in order to identify a potential emergency, such as a natural disaster, man-made disaster, personal financial emergency, or the like. These outlets may include web based outlets. In some embodiments, as illustrated in block 308, the system may identify customer resource level within his/her accounts at the entity.

Next, as illustrated in block 310, the process 300 continues by identifying a potential emergency and a user associated with the emergency based on third party media outlets and customer resource level extraction. In this way, the system may identify a geographic location associated with an emergency, such as a natural disaster or the like based on indications of an emergency from news outlets within a geographic location of the user based on the user home zip code. In some embodiments, the system may identify the occurrence of an emergency based on social network outlets and postings associated with a user and/or a geographic location. In some embodiments, the system may identify the occurrence of an emergency based on user specific factors, such as a low resource balance, insurance, or the like. In some embodiments, a combination of news outlet, geographic location, user specific factors, and social media outlets may be used to identify and provide an indication of a potential emergency effecting the user.

Once a potential emergency is identified for a user, the system may confirm the user safety, eligibility for the resource distribution depository network, and user contacts to include in the resource distribution depository network. As illustrated in block 312, the process 300 is completed upon integration within the social awareness network and the system may generate a message to the user via the network for confirmation of safety and triggering of resource distribution network deployment for the user. Furthermore, the system may identify one or more needs of the user, such as resources, food, shelter, water, or the like. The system may be able to deploy and display those needs to the user contacts for the user contacts to provide items or prepaid resource cards associated with stores for the desired products.

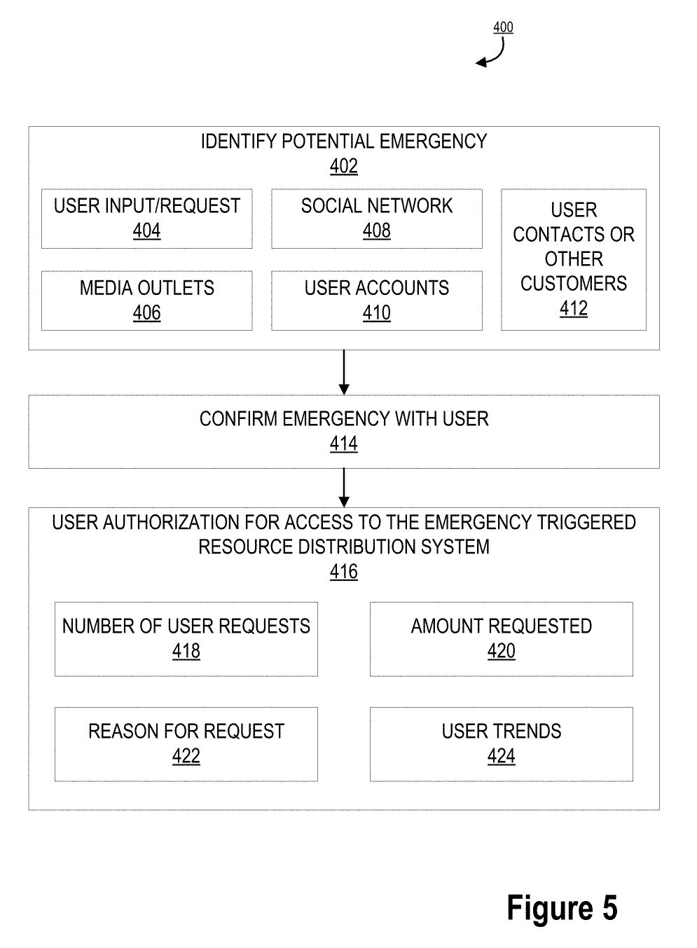

FIG. 5 illustrates a process for validation authorization for deployment of emergency triggered resource distribution network 400, in accordance with embodiments of the present invention. As illustrated, FIG. 5 provides a system determination of a potential emergency and confirmation of user authorization to have access to a system generated resource distribution depository network. As illustrated in block 402, the process 400 is initiated by identifying a potential emergency associated with a customer. These emergencies may be identified from user input/request 404, media outlet review 406, social network review 408, user accounts 410, and/or from user contacts or other customers of the entity 412.

In some embodiments, the system may receive user input/request 404 identifying an emergency. In this way, the user may provide input via a user device to identify a potential emergency associated with the user. The user may input via a display on the user device and the input may be communicated to the system via a network.

In some embodiments, the system may utilize a review of media outlets 406 identifying an emergency. In this way, the system may monitor and review media outlets, such as news outlets, weather outlets, and the like to identify an emergency occurrence at the same zip code or geographic location as a customer. In this way, the news outlets or weather outlets may provide an indication that an emergency has or will occur.

In some embodiments, the system may utilized a review of social networks 408 identifying an emergency. In this way, the system may identify communications, posts, links, or the like associated with social media outlets to identify a potential emergency situation associated with a user.

In some embodiments, the system may utilize a review of user accounts 410 identifying an emergency. In this way, the system may review a resource amount available to the user in one or more user accounts managed by the entity associated with the system. In this way, the system may identify a potential emergency associated with the review of the user account and/or a potential low resource availability for the user in connection with one or more emergencies identified via other means.

In some embodiments, the system may receive indication of an emergency from user contacts or other customers of the entity 412. As such, a user contact or other customer in the geographic area of the user may communicate with the system to identify an emergency that occurred to or near the user that has an impact on the user.

Next, as illustrated in block 414, the process 400 continues by confirming an occurrence of an emergency with the user. In this way, the system may communicate with the user via the user device. The system may communicate with the user via social networking application, text message, voice message, email, or the like.

The user may then approve the generation of a resource distribution depository network for the user. As illustrated in block 416, the process 400 continues by confirming user authorization for access to a resource distribution depository network. In this way, the system confirms that the user is authorized to receive a resource distribution depository network set up for him/her. The system determines user eligibility based on factors such as the number of user requests 418, the reason for the request 422, the amount requested 420, and user trends 424. In some embodiments a single factor is used to determine the user eligibility for the resource distribution depository network. In other embodiments, multiple factors are used to determine user eligibility for resource distribution depository network.

In some embodiments, the system determines user eligibility based on the number of user requests 418. In this way, the system may limit the number of resource distribution depository networks generated for the user within a year time period. In this way, the system monitors the user of the resource distribution depository networks and ensures no misappropriation of the system. In some embodiments, the system determines user eligibility based on the reason for the request 422. In this way, the system may utilize the user reason for the request as a factor to determine user eligibility for the resource distribution depository network. In some embodiments, the system determines user eligibility based on the amount requested 420. As such, the user may request an amount of resources to aid in the emergency associated with the user. In some embodiments, the system determines user eligibility based on user trends 424. In this way, the user may have resource distribution trends or trends in utilization of previously provided resource distribution depository networks that may indicate a use of resources not associated with the emergency and may prevent eligibility of the user for a subsequent resource distribution depository network.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource distribution depository network deployment, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
interconnect with a digital resource distribution network for generation of a resource distribution depository network for a user based on triggering of an event;
generate a communicable linkage with an emergency confirmation network comprising third party systems;
trigger, based on identification of a user experiencing an event, a generation of the resource distribution depository network for the user;
communicate with emergency confirmation network to confirm event occurrence;
transmit a communication to the user confirming the user safety after the event;
generate the resource distribution depository network via communication with the digital resource distribution network;
communicate the resource distribution depository network to a user contact network with one or more user contacts based on user authorization for the resource distribution depository network; and
allow resource distribution from the user contact network to the user via the resource distribution depository network.

2. The system of claim 1, wherein generating the resource distribution depository network via communication with the digital resource distribution network further comprises integration within the digital resource distribution network and manipulating the digital resource distribution network for generation of an individual directed resource distribution depository network for the user.

3. The system of claim 1, wherein the emergency confirmation network comprises communicably linked third party network servers associated with media outlets, weather outlets, social network outlets, and resource deployment outlets.

4. The system of claim 1, wherein an event is an emergency or natural disaster negatively impacting the user resource availability, physical health, or property health.

5. The system of claim 1, wherein identification of the user experiencing an event further comprises receiving communication from the user of the event and a request for the generation of the resource distribution depository network for the user.

6. The system of claim 1, wherein identification of the user experiencing an event further comprises receiving communication from the emergency confirmation network or user contact network providing an indication of the event for a user.

7. The system of claim 1, wherein authorizing the user for the resource distribution depository network further comprises filtering factors of a number of user requests received this year, a reason for a request, a resource amount requested, and user resource trends for user authorization for generation of the resource distribution depository network.

8. The system of claim 1, wherein the user contact network further comprises one or more individuals linked to the user via social network contacts of the user or phonebook contacts of the user.

9. A computer program product for resource distribution depository network deployment with at least one non-transitory computer-readable medium having computer-readable program code portions embodied therein, the computer-readable program code portions comprising:
an executable portion configured for interconnecting with a digital resource distribution network for generation of a resource distribution depository network for a user based on triggering of an event;
an executable portion configured for generating a communicable linkage with an emergency confirmation network comprising third party systems;
an executable portion configured for triggering, based on identification of a user experiencing an event, a generation of the resource distribution depository network for the user;
an executable portion configured for communicating with emergency confirmation network to confirm event occurrence;
an executable portion configured for transmitting a communication to the user confirming the user safety after the event;
an executable portion configured for generating the resource distribution depository network via communication with the digital resource distribution network;
an executable portion configured for communicating the resource distribution depository network to a user contact network with one or more user contacts based on user authorization for the resource distribution depository network; and
an executable portion configured for allowing resource distribution from the user contact network to the user via the resource distribution depository network.

10. The computer program product of claim 9, wherein generating the resource distribution depository network via communication with the digital resource distribution network further comprises integration within the digital resource distribution network and manipulating the digital resource distribution network for generation of an individual directed resource distribution depository network for the user.

11. The computer program product of claim 9, wherein the emergency confirmation network comprises communicably linked third party network servers associated with media outlets, weather outlets, social network outlets, and resource deployment outlets.

12. The computer program product of claim 9, wherein an event is an emergency or natural disaster negatively impacting the user resource availability, physical health, or property health.

13. The computer program product of claim 9, wherein identification of the user experiencing an event further comprises receiving communication from the user of the event and a request for the generation of the resource distribution depository network for the user.

14. The computer program product of claim 9, wherein identification of the user experiencing an event further comprises receiving communication from the emergency confirmation network or user contact network providing an indication of the event for a user.

15. The computer program product of claim 9, wherein authorizing the user for the resource distribution depository network further comprises filtering factors of a number of user requests received this year, a reason for a request, a resource amount requested, and user resource trends for user authorization for generation of the resource distribution depository network.

16. The computer program product of claim 9, wherein the user contact network further comprises one or more individuals linked to the user via social network contacts of the user or phonebook contacts of the user.

17. A computer-implemented method for resource distribution depository network deployment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
interconnecting with a digital resource distribution network for generation of a resource distribution depository network for a user based on triggering of an event;
generating a communicable linkage with an emergency confirmation network comprising third party systems;
triggering, based on identification of a user experiencing an event, a generation of the resource distribution depository network for the user;
communicating with emergency confirmation network to confirm event occurrence;
transmitting a communication to the user confirming the user safety after the event;
generating the resource distribution depository network via communication with the digital resource distribution network;
communicating the resource distribution depository network to a user contact network with one or more user contacts based on user authorization for the resource distribution depository network; and
allowing resource distribution from the user contact network to the user via the resource distribution depository network.

18. The computer-implemented method of claim 17, wherein generating the resource distribution depository network via communication with the digital resource distribution network further comprises integration within the digital resource distribution network and manipulating the digital resource distribution network for generation of an individual directed resource distribution depository network for the user.

19. The computer-implemented method of claim 17, wherein identification of the user experiencing an event further comprises receiving communication from the user of the event and a request for the generation of the resource distribution depository network for the user.

20. The computer-implemented method of claim 17, wherein authorizing the user for the resource distribution depository network further comprises filtering factors of a number of user requests received this year, a reason for a request, a resource amount requested, and user resource trends for user authorization for generation of the resource distribution depository network.
